(19) United States
(12) Patent Application Publication
(10) Pub. No.: US 2007/0076251 A1
(43) Pub. Date: Apr. 5, 2007

(54) System and Device for Image Reading

(75) Inventor: Masaru Yasuda, Nagoya, Aichi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya (JP)

(21) Appl. No.: 11/535,391

(22) Filed: Sep. 26, 2006

(30) Foreign Application Priority Data
Sep. 30, 2005 (JP) 2005286461

(51) Int. Cl. G06F 3/12

(52) U.S. Cl. 358/1.15; 358/474

(57) ABSTRACT

There is provided a network system, which comprises an image reading device and an image display device connected to the image reading device via a network. In the network system, the image reading device comprises a reading unit to read an image from an original and to generate image data, a communication unit, a communication controller to activate the reading unit and to transmit the image data to the image display device in response to receipt of an image transfer instruction. The image display device comprises a communication unit, a instruction input unit through which the image transfer instruction is inputted, a communication controller to transmit the image transfer instruction inputted through the instruction input unit to the image reading device, and a display control unit to display an image corresponding to the image data in response to receipt of the image data.

### CROSS-REFERENCE TO RELATED APPLICATION

This application claims priority under 35 U.S.C. §119 from Japanese Patent Application No. 2005-286461, filed on Sep. 30, 2005. The entire subject matter of the application is incorporated herein by reference.

### BACKGROUND

1. Technical Field

Aspects of the present invention relate to a network system in which image data generated by an image reading device is shared between devices.

2. Related Art

Various types of home network systems have become widespread. One of home networks is disclosed in Japanese Patent Provisional Publication No. 2002-319947. Recently, a technical standard DLNA™ (Digital Living Network Alliance) has been proposed. The DLNA™ relates to a technology for sharing data (e.g., audio data, still image and moving image data) between devices, such as home information appliances, mobile devices and personal computers. In a home network system complying with the DLNA™, each of home information appliances is able to operate or reproduce contents stored in a PC (personal computer). An example of such a home network system complying with the DLNA™ is disclosed on a web site “http://japan.cnet.com/news/tech/story/0,2000047674,20074987,00.htm”, “DLNA guaranteeing interconnection between PC/Home Appliance”, Oct. 6, 2004, Michko Nagai, CNET JAPAN (searched on Sep. 16, 2005).

### SUMMARY

Aspects of the present invention are advantageous in that a network system capable of effectively providing image data corresponding to an image read by an image reading device to a device on which the image is to be displayed.

### BRIEF DESCRIPTION OF THE ACCOMPANYING DRAWINGS

FIG. 1 is a block diagram of a network system according to a first embodiment of the invention.

FIG. 2 shows a folder structure in a storage unit of a multifunction peripheral provided in the network system according to the first embodiment.

FIG. 3 shows an example of a file selection screen displayed on a display unit of a television provided in the network system according to the first embodiment.

FIG. 4 is flowchart illustrating a file transmission process executed by the multifunction peripheral according to the first embodiment.

FIG. 5 is a flowchart illustrating an update notification process executed by the multifunction device according to the first embodiment.

FIG. 6 is a flowchart illustrating an instruction transmission process executed by the television according to the first embodiment.

FIG. 7 is a flowchart illustrating a reproduction process executed by the television according to the first embodiment.

FIG. 8 shows a folder structure in a storage unit of a multifunction peripheral provided in a network system according to a second embodiment.

FIG. 9 shows an example of a file selection screen displayed on a display unit of a television provided in the network system according to the second embodiment.

FIG. 10 is flowchart illustrating a file transmission process executed by the multifunction peripheral according to the second embodiment.

FIG. 11 shows another example of a folder structure in the storage unit of the multifunction peripheral.

FIG. 12 shows another example of a file selection screen displayed on the display unit of the television.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to an aspect of the invention, there is provided a network system, which comprises an image reading device having a function of reading images, and an image display device having a function of displaying images communicatably connected to the image reading device via a network. In the network system, the image reading device comprises a reading unit configured to read an image from an original and to generate image data corresponding to the read image, a reading device side communication unit configured to perform data communication with the image display device via the network, a reading device side communication controller configured to activate the reading unit and to transmit the image data generated by the reading unit to the image display device through the reading device side communication unit in response to receipt of an image transfer instruction. The image display device comprises a display device side communication unit configured to perform data communication with the image reading device via the network, a instruction input unit through which the image transfer instruction is inputted, a display device side communication controller configured to transmit the image transfer instruction inputted through the instruction input unit to the image reading device through the display device side communication unit, and a display control unit configured to display an image corresponding to the image data in response to receipt of the image data through the display device side communication unit.

Such a configuration makes it possible to transmit image data obtained by the image reading device to the image display device through the network and thereby to display an image corresponding to the image data on the image display device.

In at least one aspect, the reading device side communication unit transmits the image data directly to the image display unit without storing the image data in the storage device.

Such a configuration makes it possible to directly transmit image data obtained by the image reading device to the image display device through the network and thereby to display an image corresponding to the image data on the image display device even if the image data is not stored in a storage device. That is, a user of the image display device is able to display an image corresponding to image data read by the image reading device in real time. It is possible to avoid wastefully storing unnecessary image data in a storage device.

In at least one aspect, the network system further comprises a data storing device connected to the network. In this case, the display device side communication unit of the image display device further performs data communication with the data storing device, and an image selection instruction is inputted through the instruction input unit of the image display device. Further, the data storing device comprises a storing device side communication unit configured to perform data communication with the image display device, a storage device in which image data is stored, a data extraction unit configured to extract stored image data designated by an image selection instruction from the storage device in response to receipt of the image selection instruction, and a storing device side communication controller configured to transmit the stored image data extracted by the data extraction unit to the image display device through the storing device side communication unit. The display control unit of the image display device further displays an image corresponding to the received stored image data in response to receipt of the stored image data.

In at least one aspect the data storing device is incorporated in the image reading device.

In at least one aspect, the image reading device further comprises a reading instruction input unit through which a reading start instruction for activating the image reading device is inputted, a first update notification unit configured to transmit update notification information indicating that an image read by the reading unit is updated to the image display device, through the reading device side communication unit, in response to receipt of the reading start instruction through the reading instruction input unit.

Such a configuration enables the user to know that the image read by the image reading device is updated while sitting in front of the image display device.

In at least one aspect, the update notification information includes a notification indicating update of the image read by the reading unit, preview image data representing a preview image of an updated image, and file information specifying a file corresponding to the updated image.

In at least one aspect, the image reading device further comprises a cover attached to the image reading device to cover the original placed on an original base of the image reading device, a cover state detector that detects an opened state or a closed state of a cover attached to the image reading device to cover the original placed on an original base, and a second update notification unit configured to transmit update notification information indicating that an image read by the reading unit is updated to the image display device, through the reading device side communication unit, in response to detection of transition of the cover state from the opened state to the closed state by the cover state detector.

Such a configuration enables the user to know that the image read by the image reading device is updated while sitting in front of the image display device.

In at least one aspect, the reading device side communication controller causes the reading unit to read images at predetermined time intervals, converts image data corresponding to the read images to moving image data, and transmits the moving image data to the image display device, as the image data, in response to receipt of the image transfer instruction.

By this configuration, the image display device displays a moving image corresponding to the moving image data transmitted from the image reading device. There is no necessity for the user of the image display device to input instructions for starting reading of an image each time an image to be read by the image reading device is changed.

According to another aspect of the invention, there is provided an image reading device communicatably connected to an image display device through a network. The image reading device comprises a reading unit configured to read an image from an original and to generate image data corresponding to the read image, a reading device side communication unit configured to perform data communication with the image display device via the network, and a reading device side communication controller configured to activate the reading unit and to transmit the image data generated by the reading unit to the image display device through the reading device side communication unit in response to receipt of an image transfer instruction.

Such a configuration makes it possible to directly transmit image data obtained by the image reading device to the image display device through the network and thereby to display an image corresponding to the image data on the image display device.

In at least one aspect the reading device side communication unit transmits the image data directly to the image display unit without storing the image data in a storage device.

Such a configuration makes it possible to directly transmit image data obtained by the image reading device to the image display device through the network and thereby to display an image corresponding to the image data on the image display device even if the image data is not stored in a storage device. That is, a user of the image display device is able to display an image corresponding to image data read by the image reading device in real time. It is possible to avoid wastefully storing unnecessary image data in a storage device.

According to another aspect of the invention, there is provided a computer readable medium having computer readable instructions stored thereon, which, when executed by a computer functioning as a image reading device communicatably connected to an image display device through a network, are configured to read an image from an original and to generate image data corresponding to the read image, and to activate the reading unit and transmit the image data generated by the reading unit to the image display device through the reading device side communication unit in response to receipt of an image transfer instruction from the image display device.

Such a configuration makes it possible to directly transmit image data obtained by the image reading device to the image display device through the network and thereby to display an image corresponding to the image data on the image display device.

In at least one aspect, the instructions are configured to transmit the image data directly to the image display device without storing the image data in a storage device.

Such a configuration makes it possible to directly transmit image data obtained by the image reading device to the image display device through the network and thereby to display an image corresponding to the image data on the image display device even if the image data is not stored in a storage device. That is, a user of the image display device is able to display an image corresponding to image data read by the image reading device in real time. It is possible to avoid wastefully storing unnecessary image data in a storage device.

According to another aspect of the invention, there is provided a method for providing image data from an image reading device to an image display device through a network, comprising the steps of reading an image from an original and to generate image data corresponding to the read image, and activating a reading unit in the image reading device and transmitting the image data generated by the reading unit to the image display device in response to receipt of an image transfer instruction from the image display device.

Such a configuration makes it possible to directly transmit image data obtained by the image reading device to the image display device through the network and thereby to display an image corresponding to the image data on the image display device.

In at least one aspect, the image data is transmitted directly to the image display device without storing the image data in a storage device.

Such a configuration makes it possible to directly transmit image data obtained by the image reading device to the image display device through the network and thereby to display an image corresponding to the image data on the image display device even if the image data is not stored in a storage device. That is, a user of the image display device is able to display an image corresponding to image data read by the image reading device in real time. It is possible to avoid wastefully storing unnecessary image data in a storage device.

### EMBODIMENT

Hereafter, embodiments according to the invention will be described with reference to the accompanying drawings.

### First Embodiment

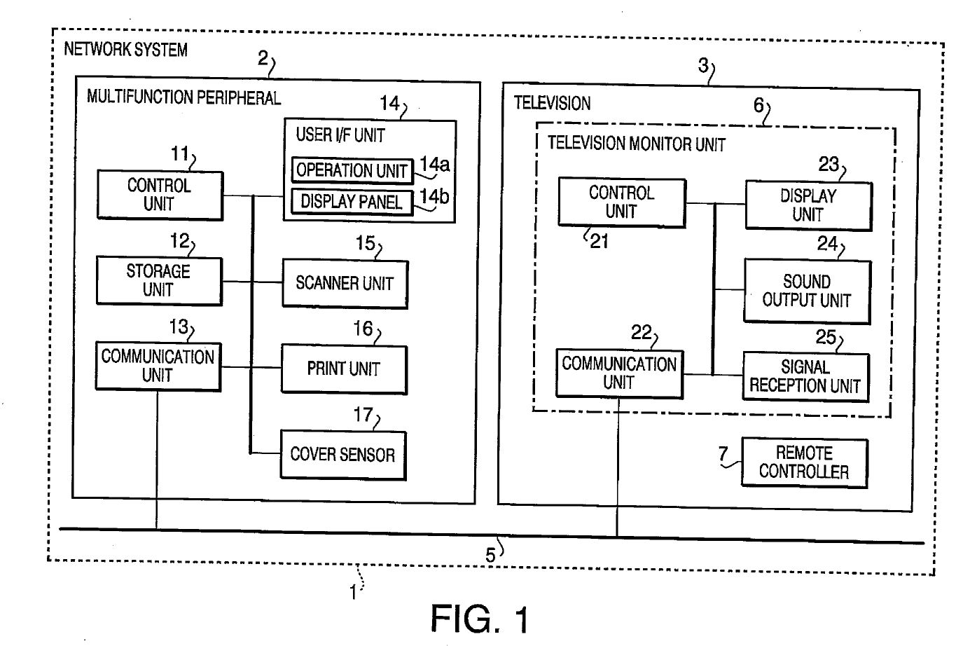

FIG. 1 is a block diagram of a network system 1 according to a first embodiment of the invention. As shown in FIG. 1, the network system 1 includes an MFP (Multifunction Peripheral) 2 and a television 3 which are communicatably connected to each other via a LAN 5. The MFP 2 has functions as a scanner and a printer.

The MFP 2 includes a control unit 11 controlling the functions of the MFP 2, a storage unit 12 (e.g., a hard disk drive or a memory card), a communication unit 13 controlling data communication with a television monitor unit 6 of the television 3 via the LAN 5, a user interface unit 14, a scanner unit 15, a print unit 16, and a cover sensor 17. The control unit 11 is formed by a microcomputer chip having a CPU, a ROM and a RAM. The user interface unit 14 includes an operation unit 14a having keys to be operated by a user, and a display panel 14b on which various types of information are displayed. The scanner unit 15 is configured to read an image from an original placed on an original base and to generate data corresponding to the image in accordance with instructions from the control unit 11. The print unit 16 is configured to form an images on a sheet of paper fed from a paper feed unit (not shown) in accordance with instructions from the control unit 11. The cover sensor 17 detects an opened or closed state of a cover (not shown) which is attached to the MFP 2 to cover a placement area of an original.

In the RAM of the control unit 11, a buffer area for storing temporarily data of images obtained by the scanner unit 15.

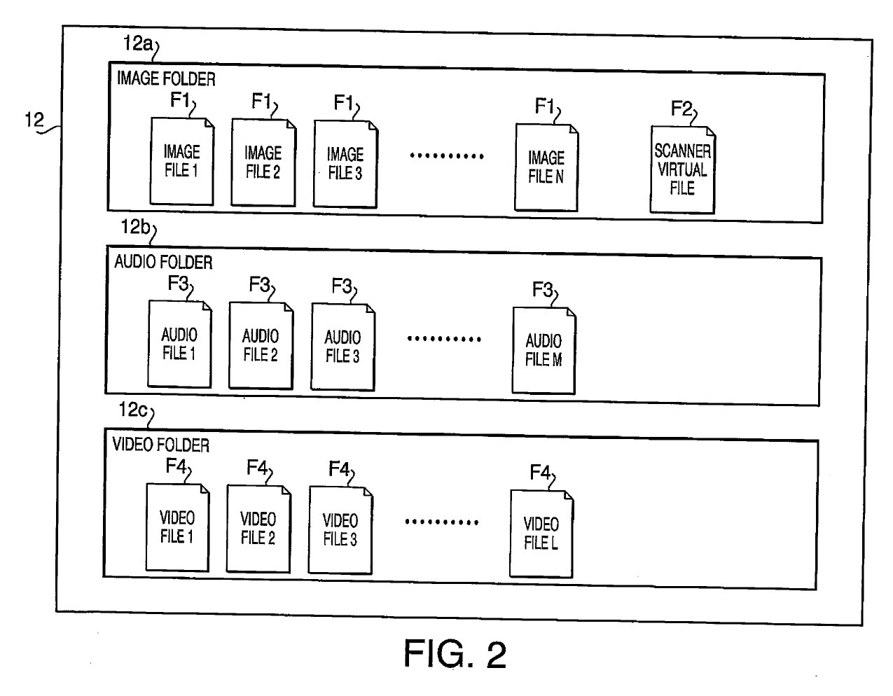

As shown in FIG. 2, the storage unit 12 includes an image folder 12a in which files of still image data (hereafter, referred to as image files) are stored, an audio folder 12b which files of sound data (hereafter referred to as audio files) are stored, and a video folder 12c in which files of moving images (hereafter, referred to video files) are stored.

In the image folder 12a, N image files (F1, F1 . . . ) and a scanner virtual file F2 used to display an icon 11 serving to activate the scanner unit 15 on the television monitor unit 6 are stored. In the audio folder 12b, M audio files (F3, F3 . . . ) are stored. In the video folder 12c, L video files (F4, F4 . . . ) are stored.

As described below, the control unit 11 of the MFP 2 executes a file transmission process to transmit image files of images read by the scanner unit 15 to the television monitor unit 6, and an update notification process to notify the television monitor unit 6 of update of images read by the scanner unit 15.

As shown in FIG. 1, the television 3 includes the television monitor unit 6 displaying images on a display unit 23 (e.g., an LCD) mounted thereon, and a remote controller 7 configured to be operated by a user to remotely control the television monitor unit 6. More specifically, the television monitor unit 6 includes a control unit 21 controlling functions of the television monitor unit 6, a communication unit 22 controlling data communication with the MFP 2 via the LAN 5, the display unit 23 for displaying images in accordance with instructions from the control unit 21, a sound output unit 24 for outputting sound in accordance with instructions from the control unit 21, an a signal reception unit 25 receiving signals from the remote controller 7.

For example, on the display unit 23, a file selection screen is displayed. The file selection screen is formed to allow the user to select a file from the files stored in the storage unit 12 and to issue an instruction for instructing the scanner 15 to start a reading operation while viewing the screen on the display unit 23 and operating the remote controller 7.

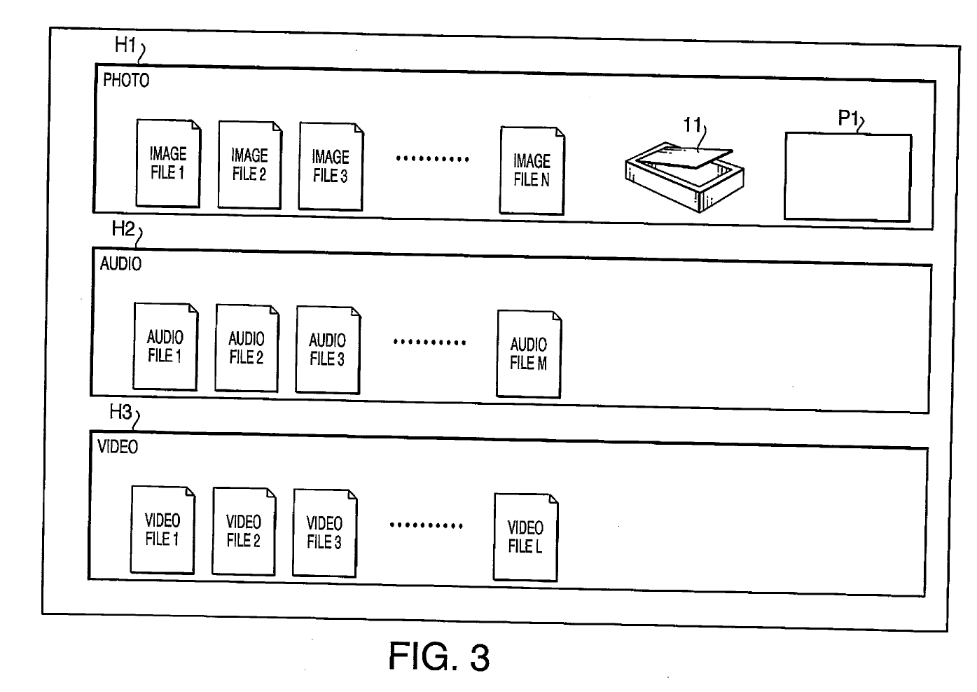

FIG. 3 shows an example of the file selection screen displayed on the display unit 23. As shown in FIG. 3, the file selection screen includes a photo display area H1 in which image files (F1, F1, . . . ) are displayed, an audio display area 112 in which audio files (F3, F3 . . . ) are displayed, and a video display area H3 in which video files (F4, F4 . . . ) are displayed. In the photo display area H1, the scanner icon I1 used to activate the scanner unit 15, a preview screen P1 in which a reduced image of an image read by the scanner unit 15 is displayed.

As described in detail below, the television monitor unit 6 executes an instruction transmission process for transmitting instructions inputted to the television monitor unit 6 through the remote controller 7 to the MFP 2, and a reproduction process for reproducing received files.

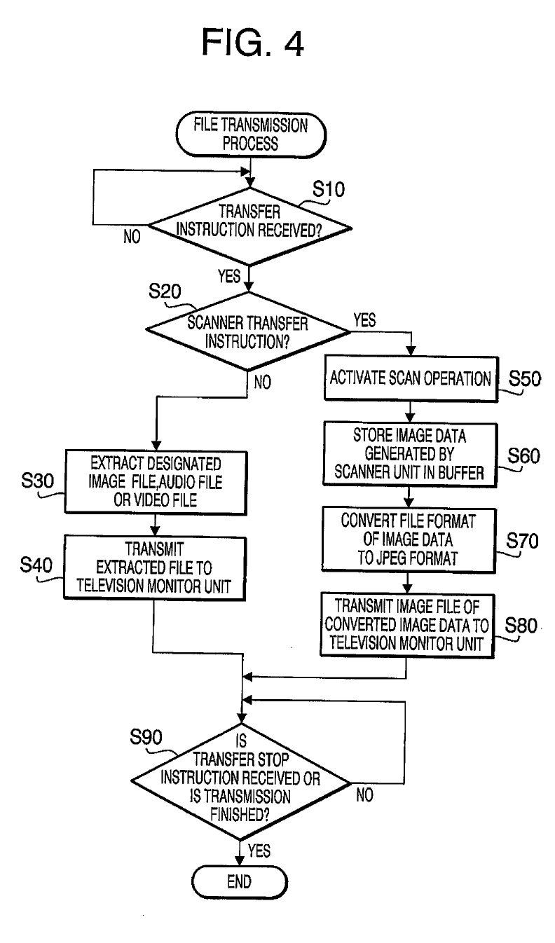

Hereafter, the file transmission process executed under control of the control unit 11 of the MFP 2 is described with reference to FIG. 4. The file transmission process is executed repeatedly during a power on state of the MFP 2.

When the file transmission process is initiated, the control unit 11 judges whether a file transfer instruction or a scanner transfer instruction has been received from the television monitor unit 6 (step S10). The control unit 11 waits until the file transfer instruction or the scanner transfer instruction is received (S10: NO). If the file transfer instruction or the scanner transfer instruction has received (S10: YES), the control unit 11 judges whether the received instruction is the scanner transfer instruction (step S20).

If the received instruction is not the scanner transfer instruction (S20: NO), the control unit 11 judges that the received instruction is the file transfer instruction and extracts an image file (F1), an audio file (F3) or a video file (F4) designated by the file transfer instruction from the storage unit 12 (step S30). Then, the control unit 11 transmits the file extracted in step S30 to the television monitor unit 6 (step S40). Then, control proceeds to step S90.

If it is judged in step S20 that the received instruction is the scanner transfer instruction (S20: YES), control proceeds to step S50 where the control unit 11 causes the scanner unit 15 to start a scanning operation to read an image from an original and to generate image data of the read image (hereafter image data of an image read by the scanner unit 15 is simply referred to as image data).

Next, the control unit 11 sores the image data generated by the scanner unit 15 into the buffer in the RAM of the control unit 11 (step S60). Next, in step S70, the control unit 11 converts a file format of a file of the image data stored in the buffer to a JPEG format. Then, the control unit 11 transmits the image data file converted in step S70 (i.e., an image file F1) to the television monitor unit 6 (step S80). Then, control proceeds to step S90.

In step S90, the control unit 11 judges whether a transfer stop instruction has been received from the television monitor unit 6 and further judges whether the file transfer is finished. If the transfer stop instruction has not been received and the file transfer is not finished (s90: NO), step S90 is repeated. If the transfer stop instruction has been received or the file transfer is finished (S90: YES), the file transmission process terminates.

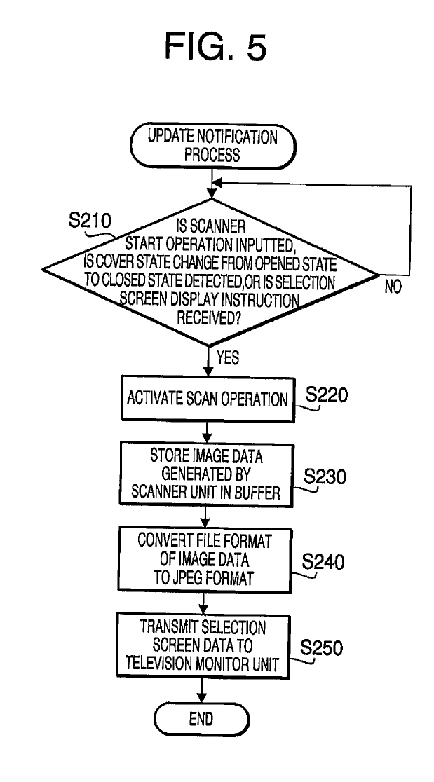

Hereafter, the update notification process executed under control of the control unit 11 of the MFP 2 is described with reference to FIG. 5. The update notification process is executed repeatedly during a power on state of the MFP 2.

When the update notification process is initiated, in step S210 the control unit 11 judges whether following three conditions stand or not:
a1) whether a user operation for instructing the MFP 2 to start a scanning operation is inputted through the operation unit 14a;
a2) whether the cover sensor 17 has detected that the cover has moved from the opened state to the closed state; and
a3) whether the control unit 11 has received a selection screen display instruction from the television monitor unit 6.

If the above three conditions do not stand (S210: NO), the control unit 11 repeats step S210. If at least one of the three conditions stands (S210: YES), the control unit 11 causes the scanner unit 15 to read an image form an original and to generate image data of the image (step S220). Then, in step S230, the control unit 11 stores the image data in the buffer in the RAM of the control unit 11.

Next, in step S240, the control unit 11 converts a file format of the image data file in the buffer to a JPEG format. Then, the control unit 11 generates data of a preview image (hereafter, referred to as preview image data) to be displayed in the preview screen P1 based on the converted image data file, update notification data indicating that the image read by the scanner unit 14 is updated, and file identification information (e.g., file names) identifying the image files (F1, F1, . . . ), the audio files (F3, F3, . . . ) and video files (F4, F4, . . . ) stored in the storage unit 12 (step S250). Further, in step S250, the control unit 11 transmits the preview image data, update notification data and file identification information to the television monitor unit 6. Hereafter, information including the preview image data, the update notification data and file identification information is referred to as selection screen data. After the data transmission is finished in step S250, the update notification process terminates.

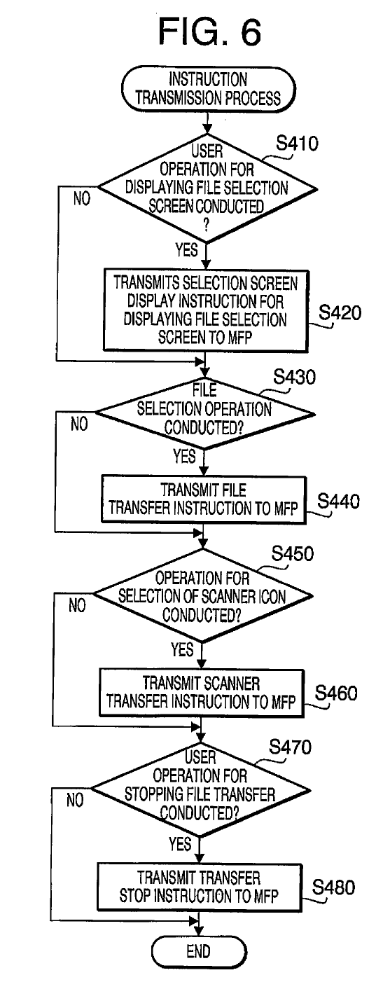

Hereafter, the instruction transmission process executed under control of the control unit 21 of the television monitor unit 6 is described with reference to FIG. 6. The instruction transmission process is executed repeatedly during a power on state of television monitor unit 6.

When the instruction transmission process is initiated, the control unit 21 judges whether a user operation for displaying a file selection screen is conducted through the remote controller 7 (step S410). If the user operation for display a file selection screen is not conducted (S410: NO), control proceeds to step S430. If the user operation for display a file selection screen is conducted (S410: YES), control proceeds to step S420 where the control unit 21 transmits a selection screen display instruction for displaying a file selection screen to the MFP 2. Then, control proceeds to step S430.

In step S430, the control unit 21 judges whether a file selection operation for selecting the image files (F1, F1, . . . ), the audio files (F3, F3, . . . ) and video files (F4, F4, . . . ) is conducted by the user through the file selection screen. If the file selection operation is not conducted (S430: NO), control proceeds to step S450. If the file selection operation is conducted (S430: YES), control proceeds to step S440 where the file transfer instruction for instructing the MFP 2 to transfer the selected file is transmitted to the MFP 2. Then, control proceeds to step S450.

In step S450, the control unit 21 judges whether a scanner selection operation for selecting the scanner icon I1 is conducted by the user using the remote controller 7 through the file selection screen. If the scanner selection operation is not conducted (S450: NO), control proceeds to step S470. If the scanner selection operation is conducted (S450: YES), control proceeds to step S460 where the scanner transfer instruction for instructing the MFP 2 to transfer image data read by the scanner unit 15 of the MFP 2 is transmitted to the MFP 2. Then, control proceeds to step S470.

In step S470, the control unit 21 judges whether a user operation for stopping the file transfer is conducted by the user through the remote controller 7. If the user operation for stopping the data transfer is not conducted (S470: NO), the instruction transmission process terminates. If the user operation for stopping the data transfer is conducted (S470: YES), control proceeds to step S480 where the transfer stop instruction for instructing the MFP 2 to stop the file transfer is transmitted to the MFP 2. Then, the instruction transmission process terminates.

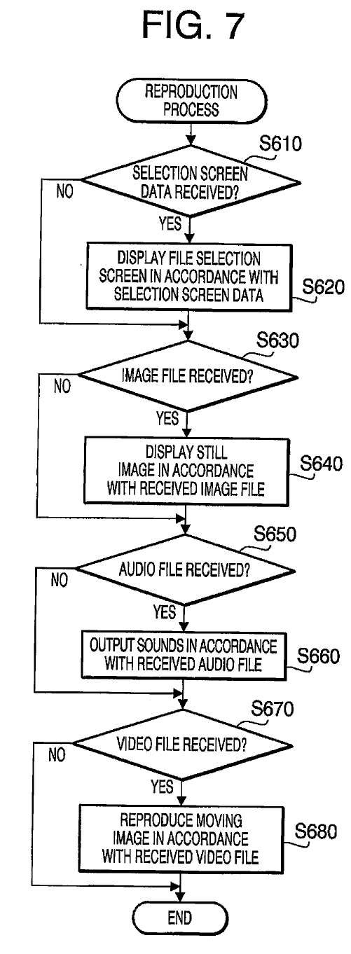

Hereafter, the reproduction process executed under control of the control unit 21 of the television monitor unit 6 is described with reference to FIG. 7. The reproduction process is executed repeatedly during a power on state of television monitor unit 6.

When the reproduction process is initiated, the control unit 21 judges whether selection screen data is received from the MFP 2. The control unit 21 waits until the selection screen data is received (S610: NO). If the selection screen data is received (S610: YES), control proceeds to step S620 where the control unit 21 displays a file selection screen corresponding to received selection screen data on the display unit 23. In the file selection screen, file names and icons representing the image files (F1, F1 . . . ), the audio files (F3, F3, . . . ) and video files (F4, F4, . . . ) are displayed in the photo display area H1, the audio display area H2 and the video display area H3. Further, the control unit 21 displays an image corresponding to the received preview image data in the preview screen P1, and controls the scanner icon I1 to blink in accordance with the received update notification data.

Next, in step S630, the control unit 21 judges whether the image files F1 from the MFP 2 have been received. If the image files F1 have not been received (S630: NO), control proceeds to step S650. If the image files F1 have been received (S630: YES), the control unit 21 displays still images corresponding to the received image files F1 on the display unit 23 (step S640). Then, control proceeds to step S650.

In step S650, the control unit 21 judges whether the audio files F3 from the MFP 2 have been received. If the audio files F3 have not been received (S650: NO), control proceeds to step S670. If the audio files F3 have been received (S650: YES), the control unit 21 outputs sounds through the sound output unit 24 in accordance with the received audio files F3 (step S660). Then, control proceeds to step S670.

In step S670, the control unit 21 judges whether the video files F4 from the MFP 2 have been received. If the video files F1 have not been received (S670: NO), the reproduction process terminates. If the video files F4 have been received (S670: YES), the control unit 21 displays moving images on the display unit 23 and outputs sounds through the sound output unit 24 in accordance with the received video files F4. Then, the reproduction process terminates.

The operations executed in the network system 1 are summarized as follows. If the user operation for display a file selection screen is conducted on the television monitor unit 6 (S410: YES), the television monitor unit 6 transmits a selection screen display instruction to the MFP 2 (step S420). After receiving the selection screen display instruction (S210: YES), the MFP 2 transmits the selection screen data to the television monitor unit 6 (step S250). After receiving the selection screen data (S610: YES), the television monitor unit 6 displays a file selection screen on the display unit 23 in accordance with the received selection screen data (step S620).

If a file selection operation is conducted by the user through the remote controller 7 on the television monitor unit 6 (S430: YES), the television monitor unit 6 transmits a file transfer instruction to the MFP 2 (step S440). After receiving the file transfer instruction (S20: NO), the MFP 2 extracts an image file F1, an audio file F3 or a video file F4 designated by the file transfer instruction from the storage unit 12 (step S30) and transmits the extracted file to the television monitor unit 6 (step S40).

Next, if the television monitor unit 6 receives the image file F1 (S630: YES), the television monitor unit 6 displays a still image corresponding to the received image file F1 on the display unit 23 (step S640). If the television monitor unit 6 receives the audio file F3 (S650: YES), the television monitor unit 6 outputs sounds corresponding to the received audio file F3 through the sound output unit 24 (step S660). If the television monitor unit 6 receives the video file F5 (S670: YES), the television monitor unit 6 displays a moving image corresponding to the received video file F5 on the display unit 23 and outputs sounds corresponding to the received video file F5 through the sound output unit 24 (step S680).

If the scanner selection operation is conducted by the user through the remote controller 7 (S450: YES), the television monitor unit 6 transmits a scanner transfer instruction to the MFP 2 (step S460). After receiving the scanner transfer instruction (S20: YES), the MFP 2 causes the scanner unit 15 to read an image from an original (step S50), and converts a file format of image data generated by the scanner unit 15 to a JPEG format (step S70), and then transmits the converted image data (i.e., the image file F1) to the television monitor unit 6 via the LAN 5 (step S80). After receiving the image file F1 (S630: YES), the television monitor unit 6 displays a still image corresponding to the received image file F1 on the display unit 23 (step S640).

With the above mentioned configuration of the network system 1, it is possible to display images on the television monitor unit 6 even if image data of the images are not stored in the storage unit 12 of the MFP 2 by directly transmitting image data read by the MFP 2 to the television monitor unit 6 via the LAN 5. In other words, it is possible to display images corresponding to image data read by the MFP 2 on the television monitor unit 6 in real time.

Since the image data generate in the MFP 2 is transmitted to the television monitor unit 6 without string the image data in the storage unit 12, it is possible to avoid wastefully storing unnecessary image data in the storage unit 12.

If a user operation for instructing the MFP 2 to start a scanning operation is inputted through the operation unit 14a or the cover sensor 17 has detected that the cover has moved from the opened state to the closed state (S210: YES), the MFP 2 transmits update notification data and preview image data to the television monitor unit 6 (step S250). After receiving the update notification data and preview image data (S610: YES), the television monitor unit 6 controls to the scanner icon I1 to blink on the file selection screen and displays a preview image in the preview screen P1 based on the received preview image data (step S620).

Such a configuration enables the user who is in the site of the television monitor unit 6 to notice the update of an image read by the MFP 2 while viewing the blinking state of the scanner icon 11 on the display unit 23 of the television monitor unit 6. The user is also able to check the updated image while viewing the preview image displayed in the preview screen P1.

### Second Embodiment

Hereafter, a second embodiment of the invention is described. Since a system configuration of a network system according to the second embodiment is substantially the same as that of the network system 1 according to the first embodiment, the system configuration of the network system according to the second embodiment is explained with reference to FIG. 1. The feature of the network system 1 according to the second embodiment is that a storing location of a scanner virtual file in the storage unit 12 is different from that of the first embodiment, the file transmission process is modified, and the update notification process is omitted. Since the network system according to the second embodiment is the modification of the network system according to the first embodiment, only the features of the second embodiment are described below.

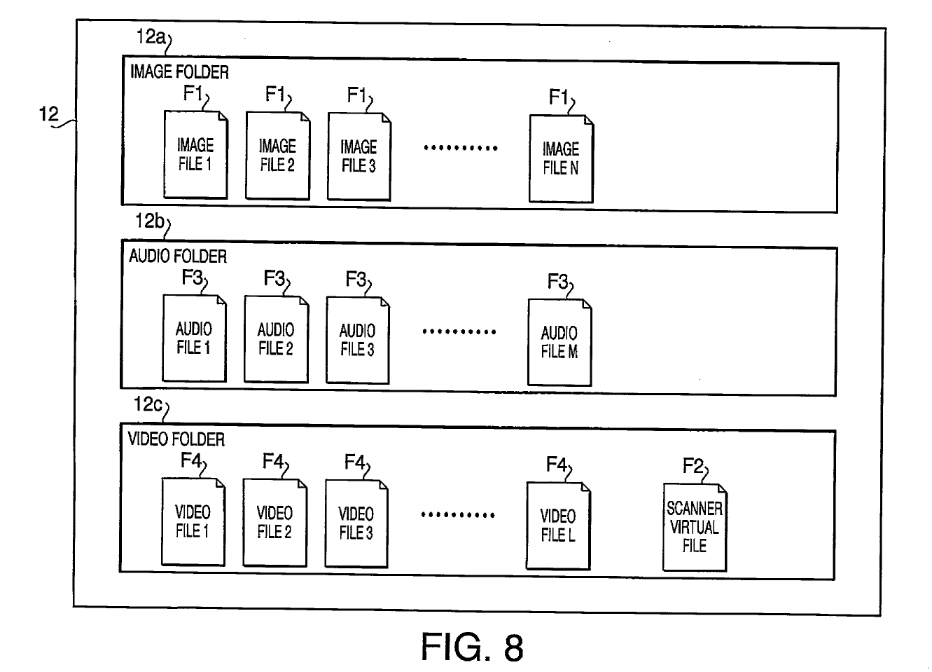

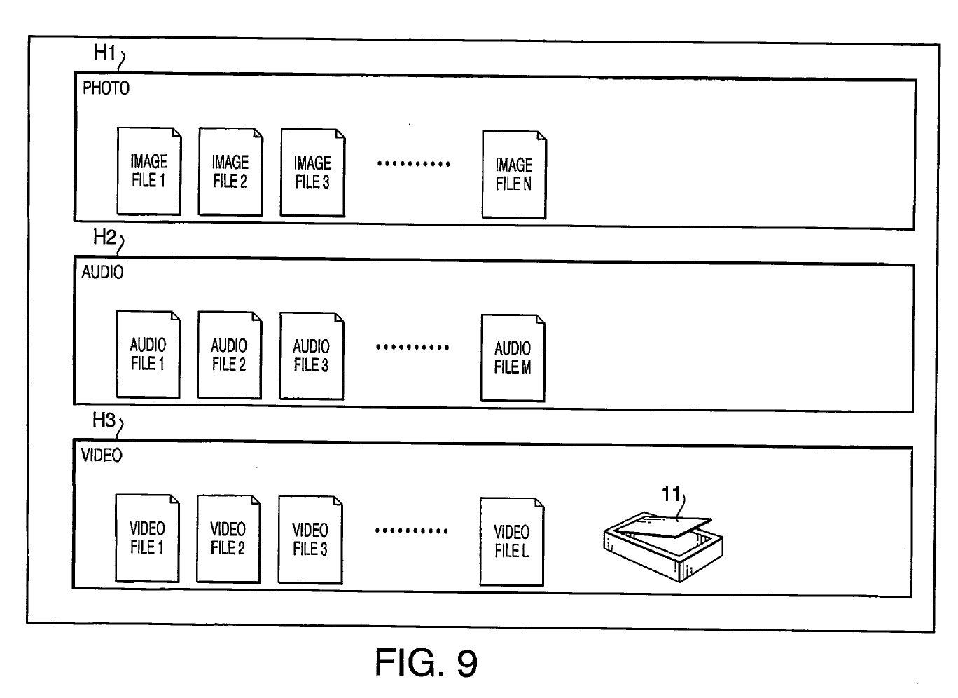

FIG. 8 shows a folder structure in the storage unit 12 according to the second embodiment. As shown in FIG. 8, the scanner virtual file F2 is stored in the video folder 12c. According the folder structure shown in FIG. 8, the scanner icon I1 is displayed in the vide display area H3 in the file selection screen (see FIG. 9).

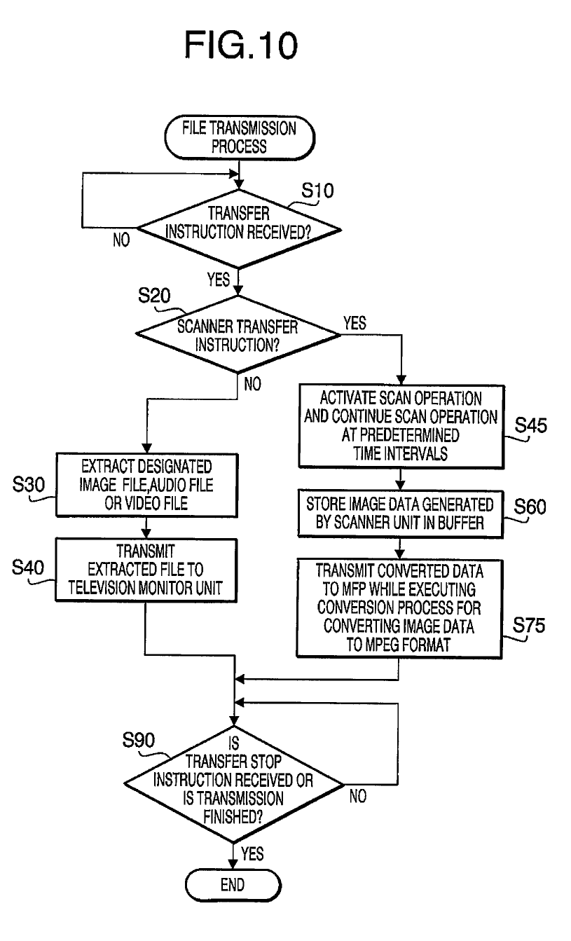

FIG. 10 is a flowchart illustrating a file transfer process according to the second embodiment. The file transfer process corresponds to modification of the file transfer process shown in FIG. 4. As shown in FIG. 10, steps S50, S70 and S80 are omitted, and steps S45 and S75 are added to the file transfer process. As shown in FIG. 10, if the received instruction is the scanner transfer instruction (S20: YES), the control unit 11 causes the scanner unit 15 to execute a reading operation repeatedly at predetermined time intervals (e.g., 5 seconds) and to generate image data corresponding to the read images (step S45). Next, the control unit 11 stores the image data generated by the scanner unit 15 in the buffer in the RAM of the control unit 11 (step S60). Then, the control unit 11 converts a file format of the image data to a MPEG format and transmits the converted data (i.e., a video file F4) to the television monitor unit 6 (step S70). More specifically, in step S70, the control unit 11 transmits converted data to the television monitor unit 6 while converting the image data to the MPEG format. Then, control proceeds to step S90.

As described above, if the scanner selection operation is conducted by the user through the remote controller 7 on the television monitor side (S450: YES), the television monitor unit 6 transmits a scanner transfer instruction to the MFP 2 (step S460). After receiving the scanner transfer instruction (S20: YES), the MFP 2 causes the scanner unit 15 to read images at the predetermined time intervals and to generate image data (step S45). Then, the control unit 11 transmits converted data to the MFP 2 while executing a conversion process for converting a file format of the image data generated by the scanner unit 15 to a MPEG format (step S75). After receiving the video file F4 (S670: YES), the television monitor unit 6 displays a moving image corresponding to the received video file F4 on the display unit 23 (step S640).

As described above, on the MFP 2, the scanner unit 15 automatically reads images at predetermined time intervals and the CPU 11 continuously transmits moving image data of the read images to the television monitor unit 6. Such a configuration enables the user to eliminate the need for inputting, on the television monitor unit 6, an instruction for instructing the MFP 2 to start the reading of an image each time the need for newly reading an image arises.

Although the present invention has been described in considerable detail with reference to certain preferred embodiments thereof, other embodiments are possible.

In the above mentioned embodiments, the storage unit 12 is incorporated in the MFP 2. However, the storage unit 12 may be mounted in a device different from the MFP 2 on the LAN 5. In this case, the device is configured to have a controller for controlling the entire functions thereof, the storage unit 12, and a communication unit controlling data communication with the television monitor unit 6.

In the above mentioned embodiments, the update notification process is configured to activate the scanner unit 15 if at least one of the three conditions is satisfied (see step S210 in FIG. 5). However, step S210 may be modified to further consider the following condition:
a4) whether a state of the MFP 2 corresponds to an initial state immediately after the power-on of the MFP 2.
   In this case, the CPU 11 causes the scanner unit 15 to start a reading operation if the condition a4) is satisfied.

In the above mentioned embodiments, image data generated by the scanner unit 15 is stored in the buffer in the RAM of the control unit 11 in step S230. Therefore, in the file transfer process, the MFP 2 may transmit image date stored in the buffer when the MFP 2 receives the scanner transfer instruction. In this case, since the need for activating the scanner unit 15 in response to the scanner transfer command, the time from the issue of the scanner transfer instruction to reception of image data can be reduced.

In the above mentioned embodiments, if the television monitor unit 6 receives the update notification data, the television monitor unit 6 causes the scanner icon I1 to blink. However, the television monitor unit 6 may control the scanner icon I1 to change color or shape thereof.

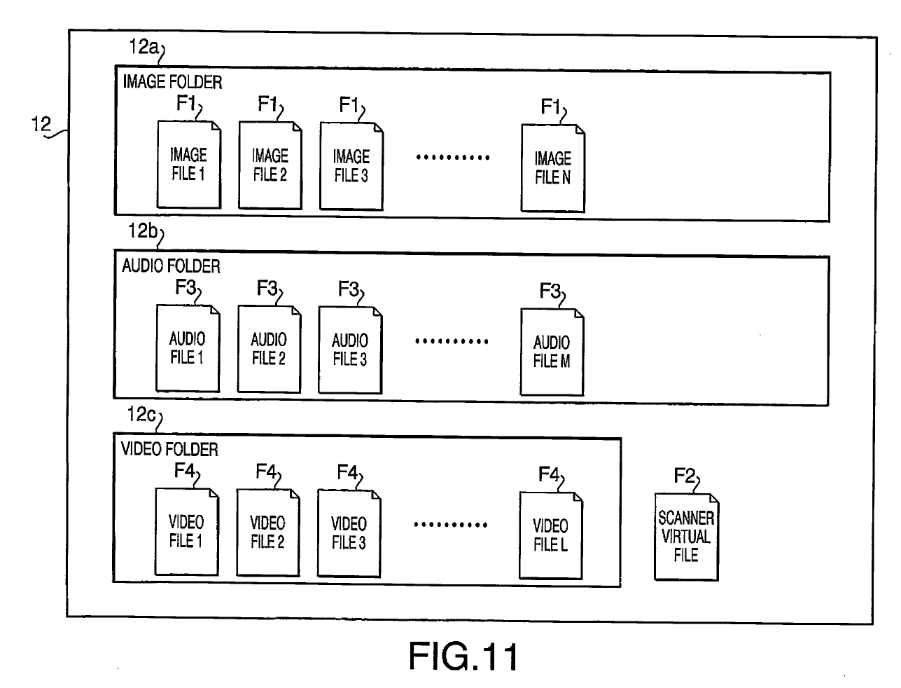

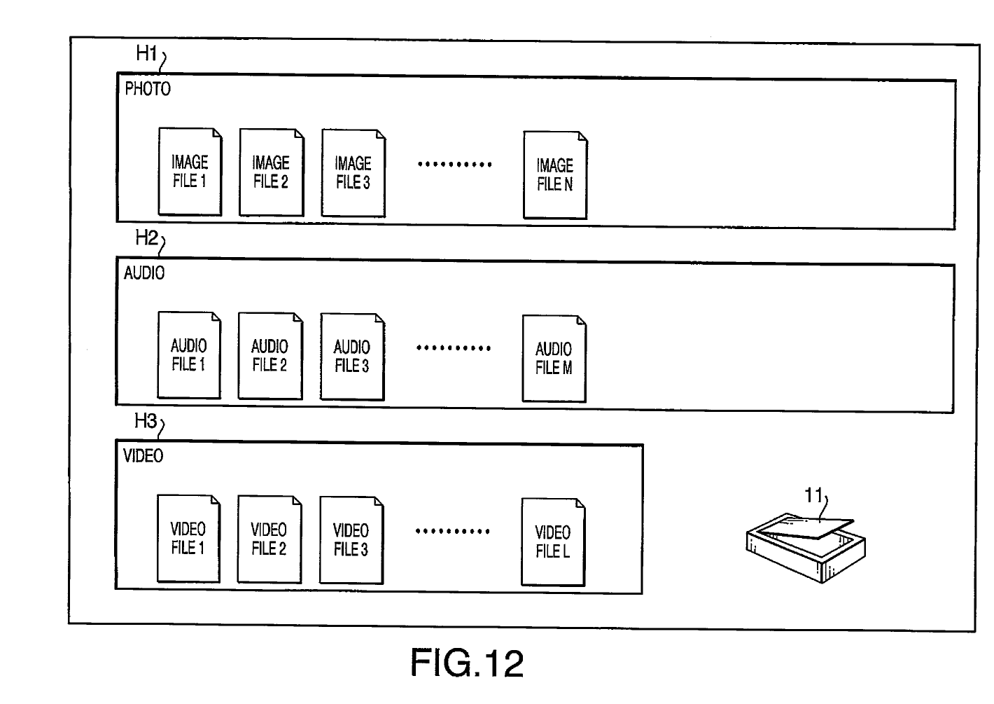

In the above mentioned embodiments, the scanner virtual file F2 is stored in the image folder 12a or the video folder 12c. However, in the storage unit 12, the scanner virtual file F2 may be stored in a layer equivalent to the image folder 12a, the audio folder 12b and the video folder 12c as shown in FIG. 11. In this case, the file selection screen is configured such that the scanner icon I1 is displayed separately from the photo display area H1, the audio display area H2 and the video display area H3 as shown in FIG. 12. That is, the scanner icon I1 is not contained in the photo display area H1, the audio display area H2 and the video display area H3.

It is understood that the functions attained by the MFP 2 may be implemented in a device of different type.

What is claimed is:

1. A network system, comprising:
an image reading device having a function of reading images; and
an image display device having a function of displaying images communicatably connected to the image reading device via a network,
wherein the image reading device comprises:
a reading unit configured to read an image from an original and to generate image data corresponding to the read image;
a reading device side communication unit configured to perform data communication with the image display device via the network;
a reading device side communication controller configured to activate the reading unit and to transmit the image data generated by the reading unit to the image display device through the reading device side communication unit in response to receipt of an image transfer instruction,
wherein the image display device comprises:
a display device side communication unit configured to perform data communication with the image reading device via the network;
a instruction input unit through which the image transfer instruction is inputted;
a display device side communication controller configured to transmit the image transfer instruction inputted through the instruction input unit to the image reading device through the display device side communication unit; and
a display control unit configured to display an image corresponding to the image data in response to receipt of the image data through the display device side communication unit.

2. The network system according to claim 1, wherein the reading device side communication unit transmits the image data directly to the image display unit without storing the image data in a storage device.

3. The network system according to claim 1, further comprising a data storing device connected to the network,
wherein the display device side communication unit of the image display device further performs data communication with the data storing device, and an image selection instruction is inputted through the instruction input unit of the image display device,
wherein the data storing device comprises:
a storing device side communication unit configured to perform data communication with the image display device;
a storage device in which image data is stored;
a data extraction unit configured to extract stored image data designated by an image selection instruction from the storage device in response to receipt of the image selection instruction; and
a storing device side communication controller configured to transmit the stored image data extracted by the data extraction unit to the image display device through the storing device side communication unit,
wherein the display control unit of the image display device further displays an image corresponding to the received stored image data in response to receipt of the stored image data.

4. The network system according to claim 3, wherein the data storing device is incorporated in the image reading device.

5. The network system according to claim 4, wherein the reading device side communication unit transmits the image data directly to the image display unit without storing the image data in the storage device.

6. The network system according to claim 1,
wherein the image reading device further comprises:
a reading instruction input unit through which a reading start instruction for activating the image reading device is inputted; and
a first update notification unit configured to transmit update notification information indicating that an image read by the reading unit is updated to the image display device, through the reading device side communication unit, in response to receipt of the reading start instruction through the reading instruction input unit.

7. The network system according to claim 6, wherein:
the update notification information includes a notification indicating update of the image read by the reading unit, preview image data representing a preview image of an updated image, and file information specifying a file corresponding to the updated image.

8. The network system according to claim 1,
wherein the image reading device further comprises:
a cover attached to the image reading device to cover the original placed on an original base of the image reading device;
a cover state detector that detects an opened state or a closed state of a cover attached to the image reading device to cover the original placed on an original base; and
a second update notification unit configured to transmit update notification information indicating that an image read by the reading unit is updated to the image display device, through the reading device side communication unit, in response to detection of transition of the cover state from the opened state to the closed state by the cover state detector.

9. The network system according to claim 1, wherein the reading device side communication controller causes the reading unit to read images at predetermined time intervals, converts image data corresponding to the read images to moving image data, and transmits the moving image data to the image display device, as the image data, in response to receipt of the image transfer instruction.

10. An image reading device communicatably connected to an image display device through a network, comprising:
a reading unit configured to read an image from an original and to generate image data corresponding to the read image;
a reading device side communication unit configured to perform data communication with the image display device via the network; and
a reading device side communication controller configured to activate the reading unit and to transmit the image data generated by the reading unit to the image display device through the reading device side communication unit in response to receipt of an image transfer instruction.

11. The image reading device according to claim 10, wherein the reading device side communication unit transmits the image data directly to the image display unit without storing the image data in a storage device.

12. A computer readable medium having computer readable instructions stored thereon, which, when executed by a computer functioning as a image reading device communicatably connected to an image display device through a network, are configured to:
read an image from an original and to generate image data corresponding to the read image; and
activate a reading unit in the image reading device and transmit the image data generated by the reading unit to the image display device in response to receipt of an image transfer instruction from the image display device.

13. The computer readable medium according to claim 12, wherein the instructions are configured to transmit the image data directly to the image display device without storing the image data in a storage device.

14. A method for providing image data from an image reading device to an image display device through a network, comprising the steps of:
reading an image from an original and to generate image data corresponding to the read image; and
activating a reading unit in the image reading device and transmitting the image data generated by the reading unit to the image display device in response to receipt of an image transfer instruction from the image display device.

15. The method according to claim 14, wherein the image data is transmitted directly to the image display device without storing the image data in a storage device.
